(19) United States
(12) Patent Application Publication
(10) Pub. No.: US 2002/0138653 A1
(43) Pub. Date: Sep. 26, 2002

(54) Workstation system, computer, data transfer method, data editing method, computer program generation method, computer program and storage medium

(75) Inventor: Hiroyuki Ogura, Yokohama-shi (JP)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY (US)

(21) Appl. No.: 10/105,123

(22) Filed: Mar. 21, 2002

(30) Foreign Application Priority Data
Mar. 21, 2001 (JP) 2001-81646

(51) Int. Cl. G06F 15/16

(52) U.S. Cl. 709/246

(57) ABSTRACT

[Object]

It is one object of the present invention to provide a system and method, whereby data can be easily and accurately exchanged by a number of different computers.

[Constitution]

Upon request from a computer 40, data that is cut or copied by an application executed by a computer 20 and is stored on a clipboard 25, is extracted by a clipboard server 26, and is transmitted via a network 10 to the computer 40. At this time, the data is transmitted in the form in which it was extracted from the clipboard 25, without being assembled into a file.

The computer 40 displays the received data using a browser executed by a browser execution unit 43. The data may be directly displayed by an application, or may be stored in a clipboard 47.

### DETAILED DESCRIPTION OF THE INVENTION

1. Field of the Invention

The present invention relates to a computer, a method, and a computer program that can appropriately be used for the exchange of data by a plurality of computers.

1. Background Art

When multiple users exchange a variety of data, such as text data and image data, via a network (e.g., the Internet, a LAN), such data is generally assembled into a file that is attached to an e-mail for transmission. Even if only a part of the text or the image data in a file is to be transmitted, that data has to be also assembled into a file.

FIG. 10 is a flowchart showing the processing performed when data is exchanged using e-mail. The shaded processes in FIG. 10 are those performed by a user.

First, a user at a computer 1 uses an application (a window) to enter a command designating an area or range of data, such as text data and image data, that is to be transmitted (step S701). The user then enters a command to cut or to copy the data within the area (step S702).

Upon entry of the command at the computer 1, an application extracts text data or image data from the designated area and stores the data on a clipboard in a storage device, such as a RAM (Random Access Memory) (step S703).

The user at the computer 1 then instructs an application to assemble a new file, and the application retrieves the data stored on the clipboard and pastes it into the new file (step S704).

Thereafter, the user enters a file name for the file in which the data has been pasted and saves the file (step S705), following which the user attaches the file to a separately prepared e-mail (step S706) and transmits the e-mail (step S707).

The e-mail transmitted by the computer 1 is received by a computer 2 via a network, such as the Internet (step S708). Then, when a user B opens the file attached to the e-mail, the data stored in the file is output to (displayed by) an application (step S709).

To use the data received from the computer 1, the user B instructs the application to cut or copy the data, and the application stores the data on a clipboard at the computer 2. Then, after the user B instructs a desired application, such as a text editor or an image editor, to paste the data stored on the clipboard in a display, the application retrieves the received data, and an editing process is performed for the data.

Each computer program developer can, for example, use multiple computers to prepare a computer program. In many cases, however, to prepare a new computer program a developer copies or changes parts of the source code for previous programs that he or she prepared. In accordance with this usage, the transfer of data within a single computer can be effected by using an editing function, such as cut or copy and paste, to easily transfer data via a clipboard without having to assemble the data into a file. However, for transmission of source code data among a plurality of computers, as well as for exchange of data among users, the data must be assembled into a file.

Also in this case, so long as the file is transmitted as an attachment to e-mail, the same processing as is shown in FIG. 10 is performed for data transmitted by the computer 1 to the computer 2.

When a LAN is constructed in a computer development environment, a data file assembled by the computer 1 can also be transmitted to the database of a server, and the computer 2 can access the database of the server to obtain the data. In the peer to peer network, the data transmission is enabled through a common folder that is sent to either the computer 1 or 2.

FIG. 11 is a flowchart showing data transmission performed using a common folder.

First, as at steps S701 to S705 in FIG. 10, a user operates the computer 1 to designate, using an application (a window), an area holding data that is to be transmitted (step S801), and instructs that the data be either cut or copied (step S802). Then, after the data in this area has been stored on a clipboard (step S803), the user employs an application to retrieve the data from the clipboard and paste it in a new file (step S804). Thereafter, the user prepares a file by entering a file name for the data (step S805) and storing the file in a predetermined directory that is set up as a common folder (step S806).

The computer 2 accesses the common folder of the computer 1 via a network (step S807), and opens the file (step S808). Then, the computer 2 uses an application to output (to display) the data stored in the file, thereby permitting the data to be used. In this manner an editing process can be performed, and the data can be copied to or cut and pasted in another application.

Recently, a function called clip book has also been provided in Windows (a trademark of Microsoft Corporation) 2000. FIG. 12 is a flowchart showing the processing performed by this function.

First, as at steps S701 to S703 in FIG. 10, the user operates the computer 1 to use an application (window) to designate an area for data to be transmitted (step S901), and instructs the data be cut or copied (step S902). Then, the computer 1 stores the data in the area on the clipboard (step S903).

Thereafter, the user issues an instruction to paste the data in a clip book that is set up in the storage area of a storage device, such as a hard disk (step S904). The computer 1 then retrieves the data from the clipboard and assembles it into a file having a predetermined form (step S905).

Then, through a user operation, the computer 2 is connected to the computer 1, via a network, and accesses the clip book (step S906). At this time the clip book at the computer 1 is used in common by both computers, 1 and 2 (step S907). Through a predetermined operation, the user thereafter designates the data (data file) that is to be obtained from the clip book at the computer 1, and issues an instruction for the data file to be stored in an arbitrary directory at the computer 2. Once the data has been obtained from the computer 1 (step S908), the computer 2 is disconnected from the computer 1 (step S909).

As a result, since the obtained data is available for use at the computer 2, an application is used to open and develop the file, and an editing process is performed to copy the data to or cut and paste it in the application.

[Problems to be Solved by the Invention]

However, according to the above described conventional method, the data must always be assembled into a file. Thus, the computer 1, the source of the data, is required to paste the data to assemble a file, provide a name for the file and specify a storage destination (data attached destination), and the computer 2, which is the recipient of the data, is required to develop the file and to cut or copy it using an application. Therefore, with the conventional method, complicated operations are required of the users even for the transmission of only a small portion of data, and further, the amount of data to be exchanged by the computers 1 and 2 is unnecessarily increased.

There is another problem. When the computers 1 and 2 use different OSs (Operating systems), especially in case the methods shown in FIGS. 11 and 12 are used, it may not be possible for the data file prepared by the computer 1 to be read (opened) by the computer 2. Therefore, before transmission an appropriate file form must be selected.

In addition, in a multiple-computer program generation environment wherein data are frequently exchanged, the extra labor required for the transmission of data is one cause of the deterioration in the efficiency of the generation of computer program.

To resolve the conventional technical problems, it is one object of the present invention to provide a workstation that can easily and accurately facilitate the transmission of data to different computers, and a computer, a data transmission method and a data editing method therefor.

It is another object of the present invention to provide a computer program generation method that will improve operating efficiency.

### SUMMARY OF THE INVENTION

To achieve the above objects, according to the present invention, upon reception of an external request from a computer other than the first computer, a first computer extracts data from a clipboard, and transmits the data to a second computer via an external network, such as the Internet or a LAN. The second computer executes an application that it uses to output the data, i.e., to display the data, or stores the data in memory, such as on a clipboard or in RAM.

For such a workstation system or a data transmission method, when one user employs multiple PCs, the data stored on the clipboard of the first computer is especially easy to transmit to the second computer. The first and second computers can be PCs or workstations, servers, or a variety of other terminals, such as portable information terminals or portable telephones having a communication function. The present invention can also be applied for a workstation that is constituted by three or more computers, when a first computer is regarded as the data transmission source and a second computer is regarded as the data recipient.

An arbitrary application can be executed by the second computer so long as a process for outputting data received via a network can be performed; specifically, a web browser can be employed. However, another application, such as a text editor or an image editor, may also be employed.

Furthermore, any type of data may be stored on a clipboard, including text and image. In this case, a standard form is used for the text or image data that is stored so that it can be retrieved from the clipboard and pasted in various applications. Therefore, even when the first and the second computers employ different OSs, the data transmitted by the first computer to the second computer can be accurately displayed by the second computer.

Further, the second computer also permits a request generator to generate a request for the extraction of data from the clipboard of the first computer and for the transmission of the data. Specifically, by using an application, such as a browser executed by a second computer, a request for data can be issued to an address that designates the section in a first computer that performs a function for the extraction of data from the clipboard and for the transmission of the data. This process can be performed in the same manner as the conventional process according to which a browser is used to obtain data from a target site via the Internet. As is described above, upon the reception of a request from a second computer, a first computer retrieves data from a clipboard and forwards the data to the second computer.

As is well known, a clipboard is used to store target data that is cut or copied by an application. After a cut or copy operation has been performed, when the application performs this operation again for another data range, the data originally stored on the clipboard is replaced, overwritten. Thus, the above described series of processes must be performed between a first and a second computer when target data to be transmitted are stored on a clipboard.

Therefore, an effective method for providing adequate data transmission coordination is for a first computer and a second computer to be equipped with inter-communication means enabling the initiation of a so-called chat, during which users can employ speech or character strings to communicate with each other. With this arrangement, when users operating first and second computers can not otherwise directly communicate with each other, communications between the computers can be established and the users can exchange messages to ensure that appropriate timing is provided for the transmission of data.

According to the invention, a computer that is a data transmission source comprises: a data storage unit, such as a clipboard or RAM, for temporarily storing data used for editing; a data extraction unit for extracting all of the data stored in the data storage unit; and a data transmission unit for transmitting, via a network, the data extracted by the data extraction unit. The data storage unit can be a so-called clipboard for storing data within the range that is specified using an application executed by the computer. The present invention can also be applied to RAM, for example. In either case, the present invention is characterized by the extraction and the transmission of all the data held by the data storage unit.

Upon the reception of a request from another computer, for example, the data extraction unit extracts data from the data storage unit and transmits the data to an address designated in the request. However, the computer constituting the transmission source can transmit data to an address designated by a user.

According to the present invention, a computer that is a data transmission source comprises: a clipboard for temporarily storing data provided in accordance with a cut or copy operation performed by as user; a data extraction unit for extracting data from the clipboard; and a data transmission unit for transmitting the extracted data via a network. The data transmission unit can transmit, using an acceptable network communication protocol format, such as HTTP, data that is extracted from the clipboard without having to assemble the data into a file. It should be noted that the type of data held by a file is indicated by an extension, such as “.txt” or “.bmp”. In this invention, however, data extracted from a clipboard is transmitted to a network as a packet.

According to the invention, a computer that is a data recipient comprises: a data reception unit for receiving, from a network, data extracted from the first clipboard of another computer; and a data output/storage unit for outputting and/or storing the data received by the data reception unit. So long as the data reception unit receives, via the network, the data in an acceptable network communication protocol format, an image based on the data can be displayed by an application, such as a browser. The received data may be stored on the clipboard of the data recipient unit.

This computer can also include a request transmission unit, such as a browser function, for transmitting to another computer a request that includes address information designating a first clipboard as a data acquisition destination.

According to the present invention, a data editing method for a computer comprises the steps of: receiving data that has been extracted from the clipboard of another computer, via a network; displaying the data at a position designated by an application executed by the computer; and editing the data using the application. The position whereat data received from another computer is to be displayed on the application is designated by a user. The designation of the position may be performed before or after the time whereat data is to be received from another computer.

Further, according to the invention, an image displayed using an application at another computer, or an image obtained by cutting or copying a portion of that image, can be received, and this received image can be stored as an image that is to be displayed if the computer is in a predetermined state. More specifically, when the computer is a portable telephone terminal, an image can be received from another computer, such as a PC, and be fetched as an image that is to be displayed when the portable telephone terminal is in a predetermined state, e.g., when a standby screen is displayed. In addition, the image can be fetched as wallpaper for the PC or the portable telephone terminal.

According to a method of generating a computer program, for the present invention, based on a cut or copy operation, a first computer stores, on a clipboard, the source code of a first computer program displayed using an application.

Thereafter, upon reception of a predetermined command, data is extracted from the clipboard and is transmitted via a network to a second computer. The second computer outputs the source code that is based on the received data to the source code of a second computer program that is displayed using an application executed by the second computer.

In this manner, when a computer program is to be prepared by first and second computers, the source code for the first computer program stored by the first computer can be cut or copied, and can be pasted in the source code for the second computer program that is prepared by the second computer.

Further, the present invention can be provided as a program that permits a computer to perform the above described process for extracting, upon the reception of a request, data stored in a memory or on a clipboard and for transmitting the data via a network, or as a storage medium on which a computer stores this computer-readable program.

[Preferred Embodiments]

The first to third embodiments of the present invention will now be described in detail while referring to the accompanying drawings.

### FIRST EMBODIMENT

FIG. 1 is a diagram for explaining the configuration of a workstation system according to a first embodiment. As is shown in FIG. 1, a computer (a first computer) 20 and a computer (a second computer or a different computer) 40 can be connected to each other via a network 10, such as the Internet or a LAN. The computers 20 and 40 are employed by the same user, and in this embodiment are used for the development (generation) of a computer program.

The computer 20, which is a PC (Personal Computer) or a workstation, comprises: an OS execution unit 21, for executing an operation based on the OS run by the computer 20; an application execution unit 22, for executing each of the applications installed on the computer 20; an application memory area 23, which is set up in a storage device, such as RAM (not shown); an input unit 24, such as a keyboard or a pointing device such as a mouse, manipulated by a user for data entry; a volatile clipboard (a data storage unit or a memory) 25, for temporarily storing data fetched by an editing operation, such as cutting or copying, for which an instruction is entered at the input unit 24; and a clipboard server 26, for exchanging data stored on the clipboard 25 with an computer.

The clipboard server 26 includes: a network access unit (data transmission unit) 27, for accessing the external network 10 via the communication interface (not shown) of the computer 20, and for transmitting and receiving data; a main processor 28, for performing the main process for the clipboard server 26; a request interpretation unit 29, a reply generator 30; and a clipboard access unit (data extraction unit) 31.

The network access unit 27 receives from the outside, more specifically, from the computer 40, a request (command) written using the communication protocol HTTP (Hypertext Transfer Protocol), for example.

When the request is received, the main processor 28 is called and transmits the request to the request interpretation unit 29. The request interpretation unit 29 interprets the contents of the request, and transmits the contents to the main processor 28. Upon the reception of the contents, as interpreted, the main processor 28 requests that the clipboard access unit 31 access the clipboard 25. The clipboard access unit 31 accesses the clipboard 25 in response to the request received from the main processor 28, and extracts the data from the clipboard 25 and transmits it to the reply generator 30.

When the data stored on the clipboard 25 is received, the reply generator 30 adds predetermined header information to the data, and generates reply data that it transmits to the network access unit 27. In accordance with a command from the main processor 28, the network access unit 27 transmits the reply data as a packet to the network 10 in accordance with the HTTP communication protocol, for example.

The computer 40, which can be a common PC or a workstation terminal, at the least includes: an OS execution unit 41, for executing the operation based on the OS of the computer 40; an input unit 42, such as a keyboard or a pointing device such as a mouse, used for data entry by a user; a browser execution unit 43, for controlling a browser that has a function for receiving data transmitted, via the network 10, using HTTP and for displaying an image based on the data; a browser memory area 44, which is set up in a storage device, such as RAM (not shown), and in which data to be displayed by the browser is stored; an application execution unit 45, for executing each of the applications; an application memory area 46, which is set up in a storage device, such as RAM (not shown); and a clipboard 47.

In the above system configuration, the user develops (prepares) a computer program. An explanation will now be given, while referring to FIG. 3, for the processing performed whereby, while a computer program in FIG. 2 is displayed using an application executed by the computer 20, the user transmits the source code for one part of the program (range (a) enclosed in FIG. 2) to the computer 40.

First, by manipulating the input unit 24 of the computer 20, using the application executed by the application execution unit 22, which is a range setting unit, the user designates the range (a) of the source code that is to be cut or copied (step S101: range designation step). Then, the user manipulates the input unit 24 to instruct either the cutting or the copying of the source code for the designated range (a) (step S102).

Upon the reception of this instruction, the computer 20 permits the application execution unit 22 to extract, from the application, the data for the source code in the range (a). At this time, since the source code displayed by the application is stored in the application memory area 23, the data for the source code in the range (a) is extracted from the application memory area 23. The extracted data is then stored on the clipboard 25 (step S103: data storage step). The processing up to this step is the same as the conventional cut or copy process.

The data that is cut or copied by the computer 20 can be stored in multiple forms on the clipboard 25, as well as on a conventional clipboard. That is, when copied data is text data representing source code, data is stored on the clipboard 25 in a unique form for an application (editor) used for the preparation of a computer program, or in any other compatible data form, such as text.

Following this, the user performs the operation entered at the input unit 42 of the computer 40 to instruct the extraction of data from the clipboard 25 of the computer 20 (step S104). Specifically, just as when the Internet site is accessed, the user enters address data, such as the URL (Uniform Resource Locators) of the clipboard server 26 of the computer 20, for the browser that is executed by the browser execution unit 43, which is the request generator or the request transmission unit, and requests that the clipboard server 26 be accessed.

Upon the reception of this instruction, the computer 40 employs a so-called get method to issue a data acquisition request via the network 10 to the clipboard server 26 of the computer 20 (step S105). The request from the computer 40 (outside) is transmitted via the network 10 to the clipboard server 26 of the computer 20. In the clipboard server 26, the network access unit 27 receives the request from the computer 40, and transmits it to the main processor 28. After the request interpretation unit 29 interprets the contents of the request, the main processor 28 employs the contents, as interpreted, request that the clipboard access unit 31 access the clipboard 25. Subsequently, the clipboard access unit 31 extracts data from the clipboard 25 (step S106: data extraction step).

The extracted data is then transmitted to the reply generator 30, and reply data is generated (step S107). The reply data is transmitted by the network access unit 27 via the network 10 to the computer 40 (step S108: data transmission step).

Following this, the data (reply data) that is extracted from the clipboard 25 of the computer 20 is transmitted to the computer 40. The computer 40 receives the replay data via the network 10 and a communication interface (not shown) (step S109: data reception step).

The replay data is stored in the browser memory area 44, and is displayed by the browser (window) that was executed by the browser execution unit 43, which is the data reception unit and the data output/storage unit (step S110: display step and output step).

As a result, the data stored in the clipboard 25 of the computer 20 is fetched to the computer 40.

Thereafter, the user, for example, cuts or copies the data that is displayed by the browser at the computer 40. Then, a position is designated using a desired application, such as a program editor, that is employed by the computer 40 for the generation of a computer program (display position designation step), and the cut or copied data is pasted in the position and displayed (display step). Thus, the data stored on in the clipboard 25 at the computer 20, i.e., the source code in the range (a) in FIG. 2, can be fetched and inserted into the computer program that is prepared by the computer 40.

As is described above, the computer 20 can cut or copy a part of the source code displayed using the application, and the computer 40 can issue a request and fetch the data stored on the clipboard 25. Therefore, the clipboard 25 at the computer 20 can be used in common by the computers 20 and 40, and the user can generate a computer program by employing the computers 20 and 40 as though they were a single computer.

The operations performed by the user are the shaded portions in FIG. 3, i.e., the user operations for the computer 20 are only (1) the designation of a range and (2) the cutting or copying instruction, and the user operation for the computer 40 is only (3) the instruction to acquire data from the computer 20. Therefore, the labor involved in the preparation of an e-mail, the assembly of data into a file and the development of a file, all of which are required by the conventional methods shown in FIGS. 10 to 12, are eliminated. As a result, the user can more efficiently develop a computer program, and this can contribute to an improvement in the speed with which the computer program is developed and a reduction in the development costs.

Further, since the data need not be assembled into a file or be attached to an e-mail, the amount of data that is exchanged by the computers 20 and 40 is minimized, and the system load is reduced.

In addition, so long as the computer 40, which is the data reception unit, includes the browser function, it can display data received from the computer 20, so that as the computer 40 a current PC is satisfactory, and no new functions need necessarily be added.

Since the data stored in the clipboard 25 includes a standard and a comparatively general-purpose form, no problems occur even when the OS execution unit 21 of the computer 20 and the OS execution unit 41 of the computer 40 employ different OSs.

Since data that is cut or copied by the computer 20 can be stored in multiple forms on the clipboard 25, as well as on a conventional clipboard, the computer 40 that receives the data can select and display data having a compatible form that the application executed by the computer 40 can handle. Conventionally, when the computer 20 and the computer 40 use different applications, data assembled into a file may not be displayed; however, according to the configuration of this embodiment, such an inconvenience can be avoided.

In the first embodiment, only the browser function is provided for the computer 40, and the computer 20 transmits data to the computer 40. However, when the same function as the clipboard server 26 of the computer 20 is provided for the computer 40, data can easily be bi-directionally exchanged by the computers 20 and 40.

In this embodiment, the computer program development environment has been employed as an example; however, the present invention is not limited to this application. Further, the data that can be handled is not limited to the source code for a computer program, and various other data types, such as text or image data, can be employed so long as the data can be fetched to the clipboard 25.

Furthermore, the computers 20 and 40 need not only be PCs or workstations, but may also be portable information terminals, such as PDAs (Personal Digital Assistants), so long as the required functions are included. Also, the computers 20 and 40 need not include the display function required for a browser, i.e., a monitor, and instead, various types of apparatuses, such as home network servers or game terminals, can be used so long as they include a function for the editing of data stored on a clipboard, a function for the extraction of data from a clipboard and a function for the transmission of data or a data reception/outputting function.

[Second Embodiment]

An explanation will now be given for a second embodiment wherein data other than the source code in the first embodiment is to be handled.

As is shown in FIG. 4, in the second embodiment, a user transmits, from a computer 20 to a portable telephone terminal 40F, a standby image that is to be displayed on a display unit 48 of the portable telephone terminal 40F.

The configuration of the computer 20 for this embodiment is essentially the same as that used for the first embodiment.

Further, the configuration of the portable telephone terminal 40F need only correspond to that of the computer 40 in the first embodiment, i.e., it must include not only a function for connecting to the network 10 and a browser display function provided by a browser execution unit 43, but also an input unit 42.

With this arrangement, a user sets, for example, a range (b) in FIG. 4 for an image IM1 that is displayed by the application executed by the computer 20, and prepares the data in the range so they can be fetched by the portable telephone terminal 40F for display as a standby image IM2 on a display unit 48.

Basically, only the processing shown in FIG. 3 in the first embodiment need be performed.

Specifically, a user at the computer 20 manipulates an input unit 24 to designate a range (b) to be cut or copied by the application (step S101). Then, the user manipulates the input unit 24 to instruct either the cutting or the copying of data in the designated range (b) (step S102).

Upon the reception of the instruction, the computer 20, using the application, extracts the data for the image (corresponding to the image IM2) in the range (b), and stores the data on the clipboard 25 (step S103).

Following this, through a predetermined manipulation of the input unit 42 at the portable telephone terminal 40F (computer 40), a user at the portable telephone terminal 40F instructs the extraction of data from the clipboard 25 at the computer 20 (step S104) Upon the reception of this instruction, the portable telephone terminal 40F issues a request to the computer 20, via the network 10, for the transmission of the data by the clipboard server 26 (step S105).

When the request is received by the clipboard server 26 of the computer 20, based on the request the clipboard access unit 31 extracts data from the clipboard 25 (step S106). Then, the reply generator 30 prepares reply data that can be transmitted via the network 10 (step S107), and then transmits the reply data, via the network 10, to the portable telephone terminal 40F (step S108).

The portable telephone terminal 40F receives the reply data from the network 10 (step S109), and based on the reply data the image IM2 is displayed on the browser (window) that is provided for the display unit 48 by the browser execution unit 43 (step S110).

Thereafter, the user need only perform a predetermined operation using the input unit 42 to store the image IM2 as a standby image for the portable telephone terminal 40F (storage step).

As is described above, according to the second embodiment, as in the first embodiment, the computer 20 can cut or copy a part of the image IM1 that is displayed by the application at the computer 20, and the portable telephone terminal 40F can easily fetch the data stored on the clipboard 25. At this time, the labor required for the operations performed by the user can be greatly reduced, and the effects whereby the data for the standby image can be easily fetched or set can be obtained.

In the second embodiment, the size of the range (b) set by the computer 20 is not particularly defined; however, the size of the range (b) may be set for the clipboard server 26 in accordance with the size of the standby image for the portable telephone terminal 40F.

[Third Embodiment]

In the first and the second embodiments, as an example, one user transfers data between the computers 20 and 40. In a third embodiment, as an example, multiple users exchange data. Further, in this embodiment, a communication function using speech, or a so-called web collaboration function, is employed. In the following explanation, the same reference numerals as are used for the first and second embodiments are also used to denote corresponding components, and no further explanation for them will be given.

FIG. 5 is a schematic diagram showing the configuration of a program transmission system according to the embodiment. A computer (first computer) 50 of a user A can communicate bi-directionally with a computer (a second computer or another computer) 60 of a user B via a network 10.

The computer 50 of the user A, which basically has the same configuration as the computer 20 in the first embodiment, comprises an OS execution unit 21, an application execution unit 22, an application memory area 23, an input unit 24, a clipboard 25 and a clipboard server 26. The clipboard server 26 transmits the data stored on the clipboard 25 in accordance with external requests received via the network 10.

The computer 60 of the user B, which also basically has the same configuration as the computer 40 in the first embodiment, comprises: an OS execution unit 41, an input unit 42, a browser execution unit 43, a browser memory area 44, an application execution unit 45, an application memory area 46 and a clipboard 47.

The computers 50 and 60 in the embodiment include collaboration execution units (communication execution units) 51 and 61, provided to enable the computer 50 and 60 to communicate with each other via the network 10. The collaboration execution units 51 and 61 each include: input means, such as a microphone, for inputting speech; coding means for coding input speech; data transmission means for transmitting coded speech data via the network 10; data reception means for receiving coded speech data via the network 10; decoding means for decoding received data; and output means, such as a loudspeaker, for outputting speech based on decoded data. Instead of using speech, character strings, such as are used for a chat, may be input/output to supply communication. Further, the image of one of the users may be recorded by a camera, and may be transmitted to another user for display.

Since the collaboration execution units 51 and 61 are provided, the computers 50 and 60 can perform bi-directional communication using speech.

With this configuration, when the user A transmits data to the user B, as is shown in FIG. 6, first the user A manipulates the input unit 24 of the computer 50 to designate a data range, such as for image data or text data, to be cut or copied by an application (step S201). Then, the user A manipulates the input unit 24 to instruct either the cutting or the copying of the data in the designated range (step S202).

Upon the reception of the instruction, the computer 50 uses an application to extract the data in the range, and stores the data on the clipboard 25 (step S203).

At this time, the user A uses the collaboration execution unit 51 to notify the user B, using speech, that the data is ready for transmission (step S204).

The user B operates the collaboration execution unit 61 of the computer 60 to receive the speech notification issued by the user A (step S205).

The user B then performs a predetermined operation using the input unit 42 of the computer 60 to instruct the extraction of the data from the clipboard 25 of the computer 50 (step S206). Upon the reception of this instruction, the computer 60 issues a request to the computer 50, via the network 10, for the transmission of the data from the clipboard server 26 (step S207).

When the clipboard server 26 of the computer 50 receives the request, the requested data is extracted from the clipboard 25 (step S208), and reply data is prepared (step S209) and is transmitted to the computer 60 via the network 10 (step S210).

When the reply data is received by the computer 60 of the user B (step S211), an image based on the reply data, i.e., an image or text in the range designated by the user A at step S201, is displayed on the browser (window) (step S212). Thereafter, through a predetermined operation performed at the input unit 42, the user B cuts or copies, and pastes the displayed image or text into another application, as needed, so as to employ the data received from the user A.

With this configuration, as in the first and the second embodiments, the data that is cut or copied by the computer 50 of the user A and is stored on the clipboard 25 can be easily fetched to the computer 60 of the user B. In this embodiment, the labor required of the users A and B for the operations can be considerably reduced, and the data transmission can be efficiently performed.

Further, since the collaboration execution units 51 and 61 are provided for the computers 50 and 60, when the user A issues a notification to the user B after having cut or copied the data and stored on the clipboard 25, the data transmission can be performed at an appropriate time even though the users A and B are widely separated, physically.

While in the third embodiment the data transmitted by the user A to the user B has not been specifically described, as in the first embodiment, text data, such as the source code for a computer program may be transmitted, or as in the second embodiment, image data may be transmitted.

In the first to third embodiments, the received data are displayed on a browser by the computer 40 or 60, which is the data reception unit. However, there are no limitation of the display methods that can be used.

For example, in the configuration in FIG. 1, when the application execution unit 45 of the computer 40 includes a function, in addition to those of the browser execution unit 43, for receiving data via the network 10 transmitted using a communication protocol such as HTTP, and for displaying an image based on the data, the data received from the computer 20 need not be displayed on the browser, but can be displayed by an application (a window) that is executed by the application execution unit 45.

FIG. 7 is a detailed flowchart showing this processing. Since steps S301 to S309 are the same as those at steps S101 to S109 in FIG. 3, no detailed explanation for them will be given. It should be noted, however, that at step S304, i.e., when the data cut or copied by the computer 20 is stored on the clipboard 25 and the computer 40 issues an instruction for the extraction of data from the clipboard 25 of the computer 20, this instruction may be provided using an application executed by the application execution unit 45. In this case, the application transmits a request having a predetermined form to the computer 20 via the network 10.

When, at step S309, the computer 40 receives from the computer 20 the reply data for the request, the computer 40 stores the reply data in the application memory area 46 set up in the RAM. And based on the reply data stored in the application memory area 46, the application executed by the application execution unit 45 displays an image or text in the range designated by the computer 20 at step S301 (step S310).

With this arrangement, as in the first embodiment, the computer 40 can use the received data directly, without the data being cut or copied from the browser and inserted into the application, and the operation performed by the user greatly simplified.

Further, the computers 40 and 60, which are the data reception units, may directly store received data on the clipboard 47, instead of displaying the data on the browser. A computer (a second computer or another computer) 70 in FIG. 8 complements the above configuration. The computer 70 comprises: a network access unit (a data reception unit) 71 in addition to an OS execution unit 41, an input unit 42, a browser execution unit 43, a browser memory area 44, an application execution unit 45, an application memory area 46 and a clipboard 47, all of which are the same as those in the computer 40 in FIG. 1 or the computer 60 in FIG. 5.

The network access unit 71 receives reply data via the network 10 from the computer 20, converts the reply data into data having the original form (the form used when the data was stored on the clipboard 25 of the computer 20), and stores the obtained data on the clipboard 47 that serves as the data output/storage unit.

FIG. 9 is a flowchart showing this processing. Since steps S401 to S409 are the same as steps S101 to S109 in FIG. 3, no detailed explanation for them will be given. In short, the computer 20 cuts or copies data within the designated range, stores the data on the clipboard 25, prepares reply data for the data and transmits the reply data in accordance with a request from the computer 70. Then, when at step S409 the computer 70 receives the reply data, the network access unit 71 converts the received reply data into data having its original form (the form used when it was stored on the clipboard 25 of the computer 20), and stores the obtained data on the clipboard 47 (step S410).

With this arrangement, as in the first embodiment, the computer 70 can directly store the received data on the clipboard 47, without the data being cut or copied from the browser to the application. Therefore, the user need only paste the data stored on the clipboard 47 into an arbitrary application to be able to use the data received from the computer 20.

In each of the embodiments, the data generally stored on the clipboard 25 is of only one type, such as text data or bitmap data; however, multiple data types may be stored on the clipboard 25 by correlating even data of the same type (e.g., text or bitmap) with history data. With this arrangement, the computers 40, 60 and 70, which are data reception units, can select data to be received from among multiple types of data stored on the clipboard 25.

In the individual embodiments, the data on the clipboard 25 of the computer 20 or 50 is extracted in accordance with a request issued by either the computer 40, 60 or 70, which is the data reception unit. However, upon the reception of a request by either the computer 20 or 50, the data may be transmitted to the computer 40, 60 or 70.

In addition, the program for performing the processes shown in the first to the third embodiments can be provided by using the storage medium or the program transmission apparatus described below.

The storage medium can be a CD-ROM, a DVD, memory or a hard disk, on or in which a computer need only store the above described computer-readable program that is to be executed.

The program transmission apparatus need only comprise: storage means, such as a CD-ROM, a DVD, memory or a hard disk, for storing the above described program; and transmission means for reading the program from the storage means and for transmitting the program via a connector or a network, such as the Internet or a LAN, to an apparatus that executes the program. This program transmission apparatus is appropriate when the program performing the above processes is installed in a computer, such as a PC.

The present invention is not limited to these embodiments, and the configurations in the embodiments can be selected and combined, or can be variously modified, as needed.

[Advantage of the Invention]

As is described above, according to the invention, data transmission among different computers can be performed easily and quickly. Furthermore, according to the invention, the efficiency with which a computer program is prepared can be increased.

### BRIEF DESCRIPTION OF THE DRAWINGS

FIG. 1 is a diagram showing the configuration of a workstation system according to a first embodiment.

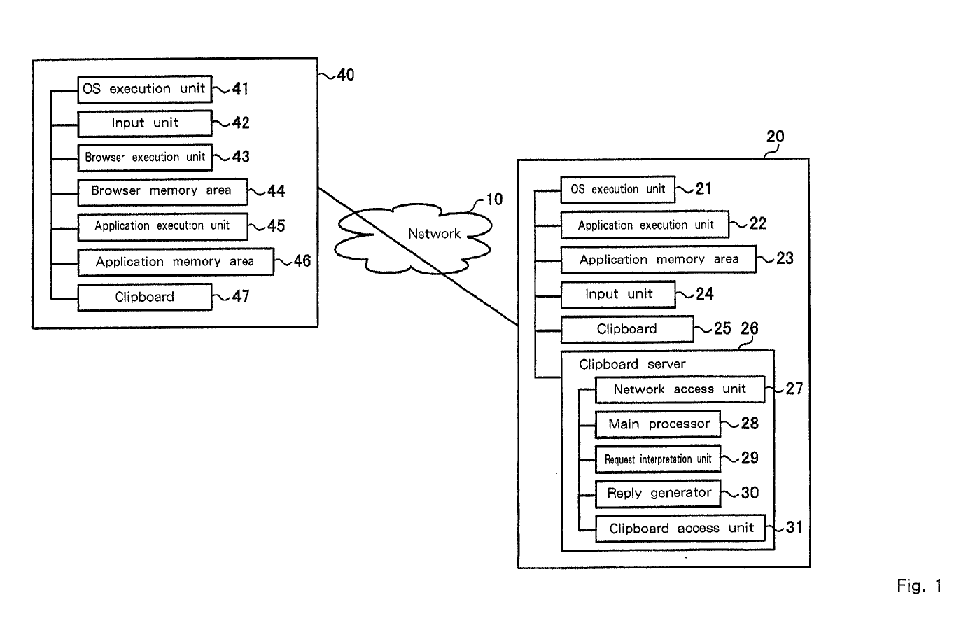

FIG. 2 is a diagram showing an example computer program that is the source for data when a computer program is to be prepared using the workstation system.

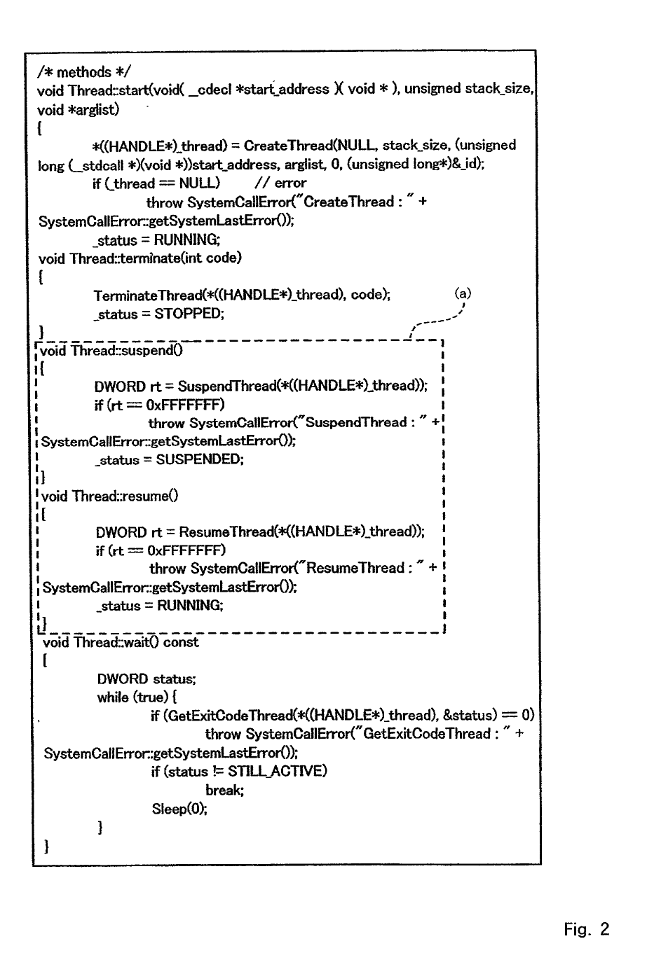

FIG. 3 is a flowchart showing the processing performed according to the first embodiment.

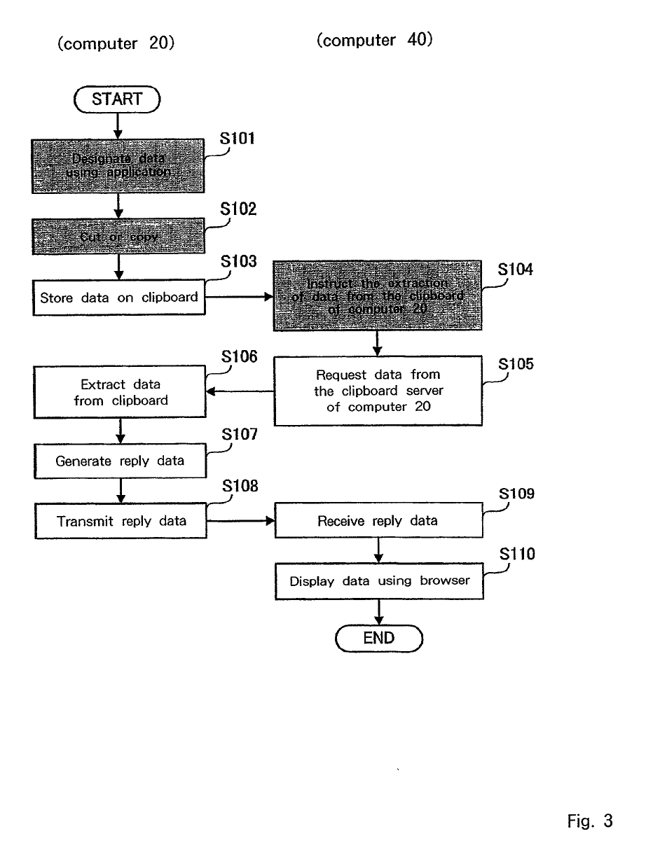

FIG. 4 is a diagram showing the configuration according to a second embodiment for the transmission of an image from a computer to a portable telephone terminal.

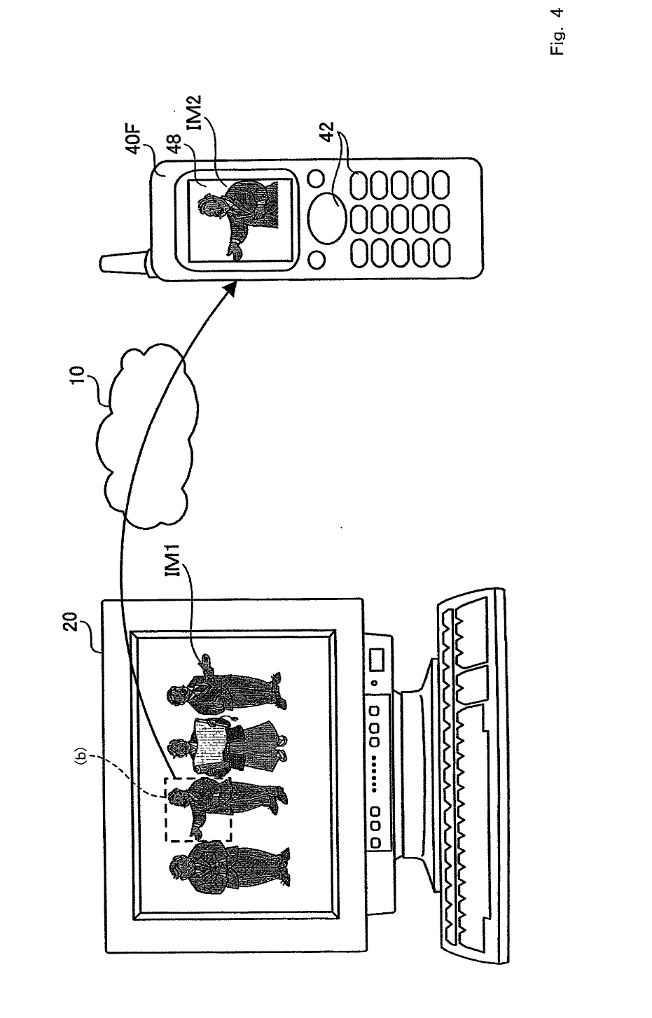

FIG. 5 is a diagram showing the configuration according to a third embodiment for the exchange of data by different users.

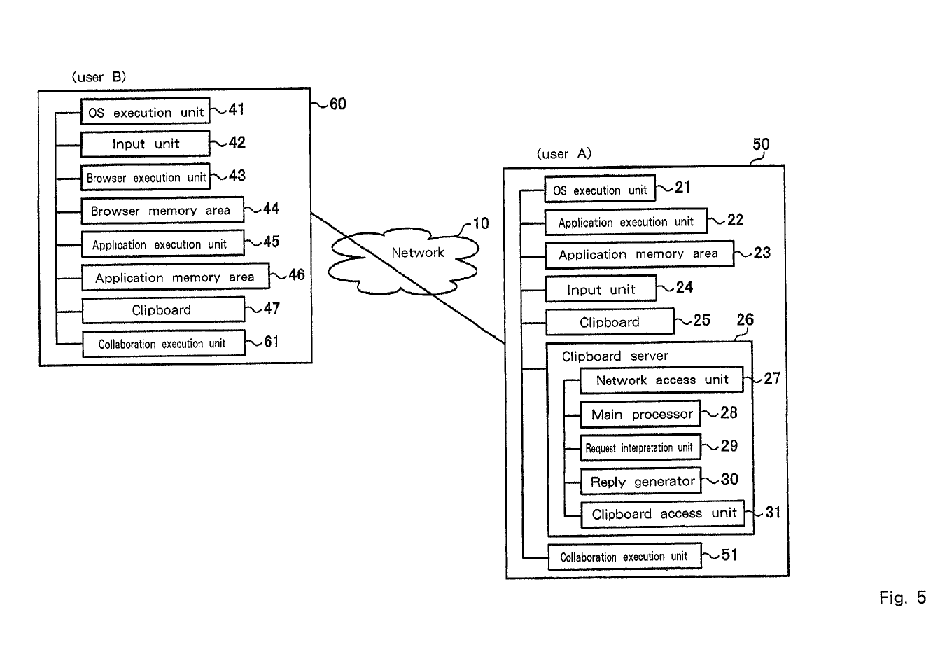

FIG. 6 is a flowchart showing example processing performed according to the third embodiment.

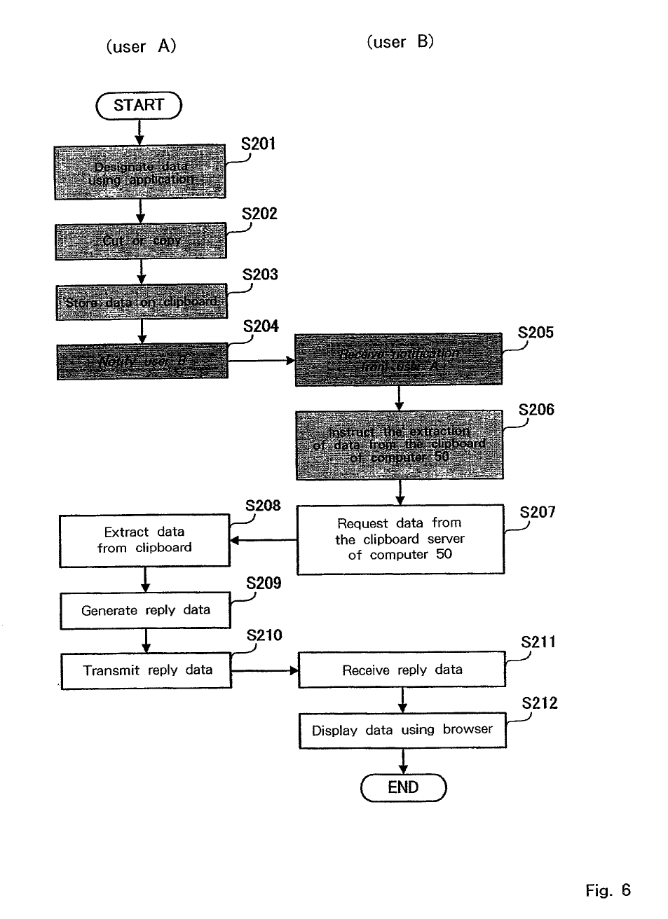

FIG. 7 is a flowchart showing another example of the processing performed for using an application to directly display received data.

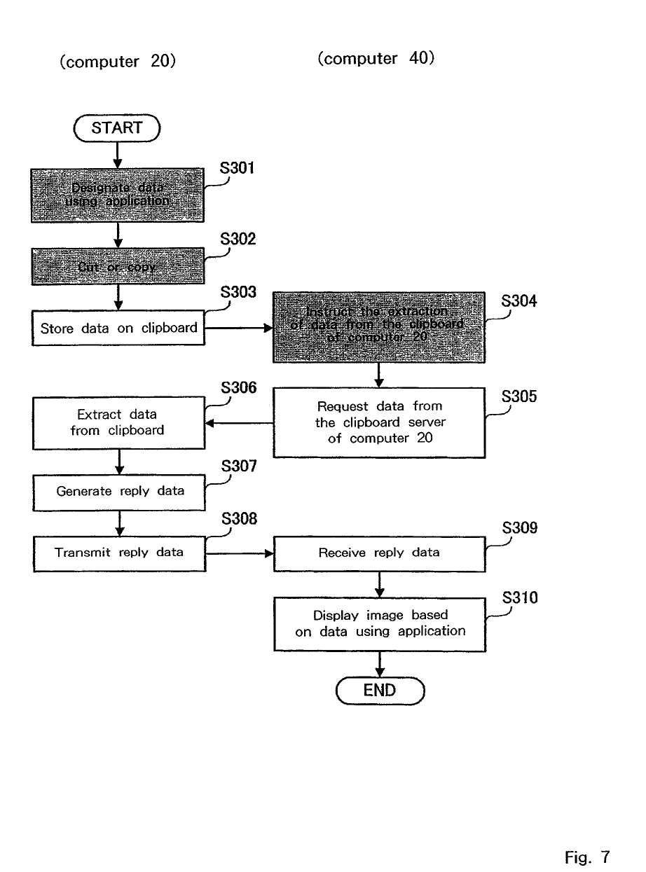

FIG. 8 is a diagram showing another configuration for storing received data on a clipboard.

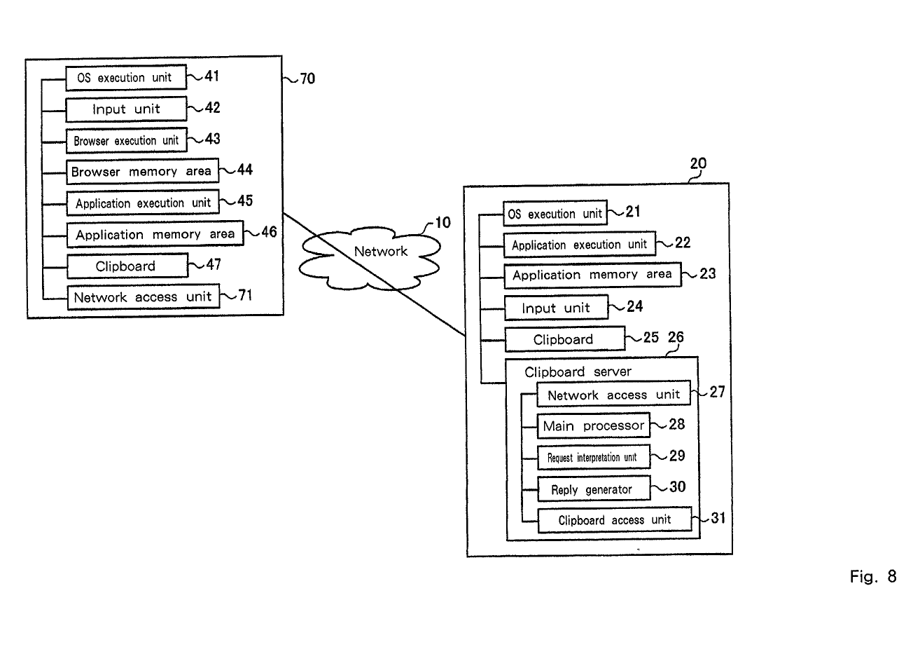

FIG. 9 is a flowchart showing the processing performed for the storage of received data on the clipboard.

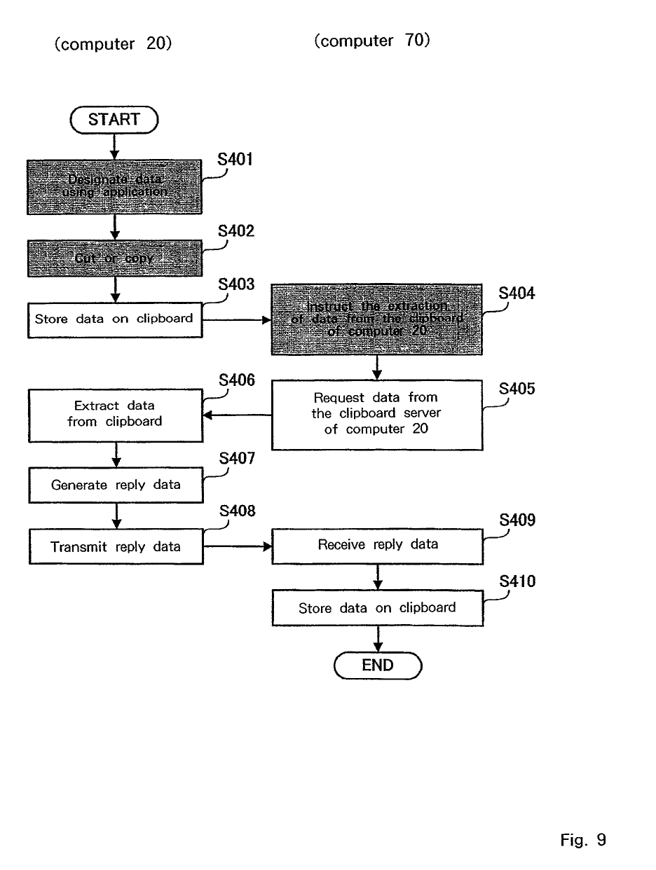

FIG. 10 is a flowchart showing a conventional data transmission processing example.

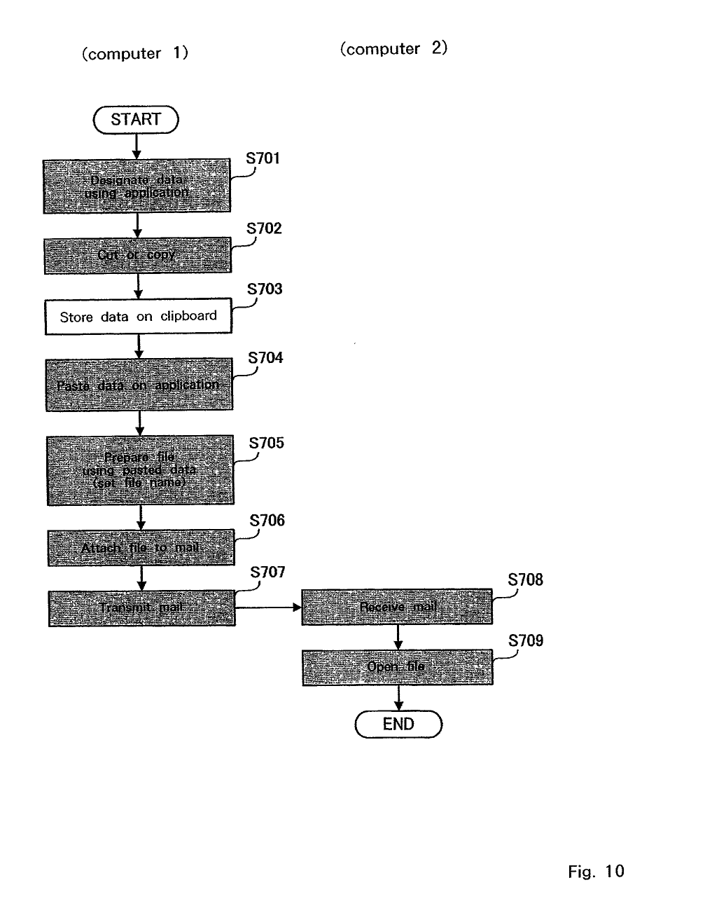

FIG. 11 is a flowchart showing another conventional data transmission processing example.

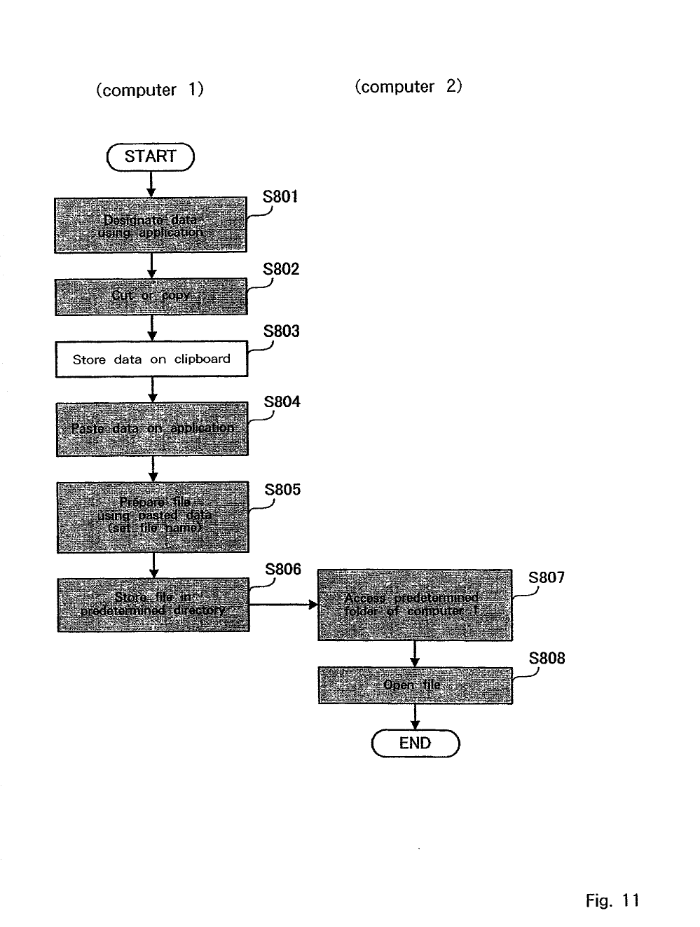

FIG. 12 is a flowchart showing an additional conventional data transmission processing example.

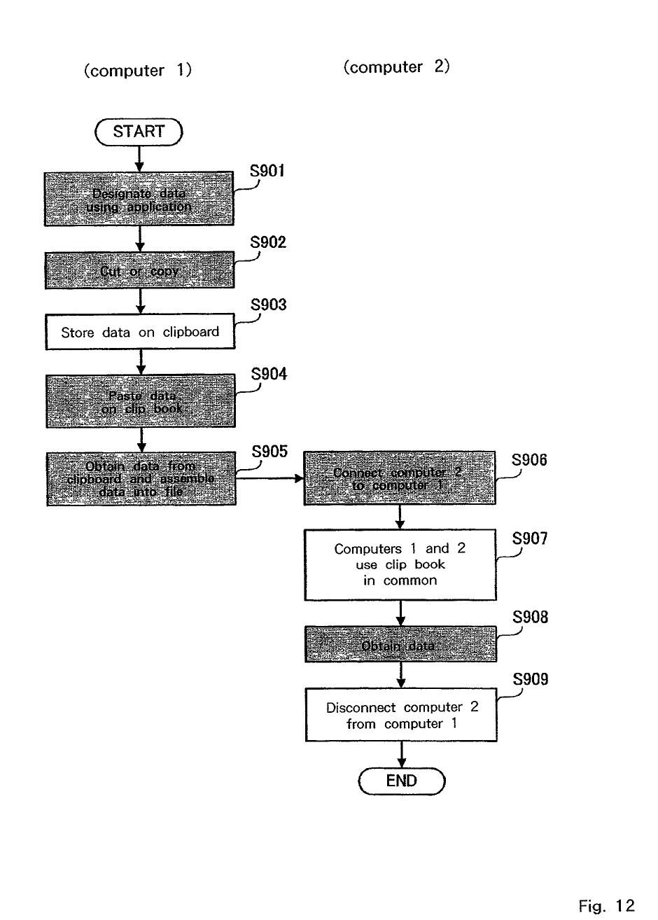

[Description of the Symbols]

10: Network

20, 50: Computer (first computer)

22: Application execution unit (range setting unit)

25: Clipboard (data storage unit or memory)

26: Clipboard server

27: Network access unit (data transmission unit)

28: Main processor

29: Request interpretation unit

30: Reply generator

31: Clipboard access unit (data extraction unit)

40, 60, 70: Computer (second computer or another computer)

40F: Portable telephone terminal

43: Browser execution unit (data reception unit, data output/storage unit, request generator or request transmission unit)

45: Application execution unit

47: Clipboard

48: Display unit

51, 61: Collaboration execution unit (communication execution unit)

71: Network access unit (data reception unit)

A, B: User

IM1, IM2: Image

1 A workstation system comprising:
a first computer and a second computer that are capable of exchanging data via a network,
wherein said first computer includes
a clipboard for temporarily storing data;
a data extraction unit for extracting data from said clipboard upon reception of a request from a computer other than the first computer, and
a data transmission unit for transmitting data extracted by said data extraction unit to said second computer via said network, and
wherein said second computer includes
a data reception unit for receiving said data from said data transmission unit via said network, and
a data output/storage unit for outputting and/or storing said data received by said data reception unit.

2 The workstation system according to claim 1, wherein said second computer further includes:
a request generator for generating a request in order to extract data from said clipboard of said first computer.

3 The workstation system according to claim 1, wherein each of said first computer and said second computer includes:
a communication execution unit for providing facilities for inter-communication using speech or character strings.

4 A computer connectable to a network comprising:
a data storage unit for temporarily storing data;
a data extraction unit for extracting all data stored in said storage unit; and
a data transmission unit for transmitting, via said network, data extracted by said data extraction unit.

5 The computer according to claim 4, wherein said data storage unit stores data within the range that is specified by a user using an application executed by said computer.

6 The computer according to claim 4, wherein, upon receiving a request, said data extraction unit extracts data from said data storage unit; and wherein said data transmission unit transmits the data extracted by said data extraction unit to an address designated in said request.

7 A computer connectable to a network comprising:
a clipboard for temporarily storing data in accordance with a cutting or copying operation by a user;
a data extraction unit for extracting data from said clipboard; and
a data transmission unit for transmitting, via said network, the data extracted by said data extraction unit.

8 The computer according to claim 7, wherein said data transmission unit transmits the data extracted by said data extraction unit to said network, using a communication protocol acceptable for said network.

9 The computer according to claim 7, further comprising:
a range setting unit for setting a range of data to be stored on said clipboard, using an application executed by said computer.

10 A computer connectable to a network comprising:
a data reception unit for extracting data from a first clipboard of a different computer and for receiving said data via said network; and
a data output/storage unit for outputting and/or storing said data received by said data reception unit.

11 The computer according to claim 10, wherein said data reception unit receives, via said network, the data transmitted using a communication protocol acceptable for said network; and wherein said data output/storage unit presents a display based on said data.

12 The computer according to claim 10, further comprising:
a second clipboard for temporarily storing data,
wherein said data output/storage unit stores the data received by said data reception unit on the second clipboard.

13 The computer according to claim 10, further comprising:
a request transmission unit for transmitting, to said different computer, a data request that includes address information designating said first clipboard as the transmission destination.

14 A method of transmitting data stored in a volatile memory of a computer to a different computer via a network, comprising the steps of:
extracting data from said volatile memory if a predetermined command is received by said computer; and
transmitting said extracted data, via said network, to said different computer using a communication protocol acceptable for the network.

15 The method according to claim 14, further comprising the steps of:
designating a range of data, using an application executed by said computer, before said data is extracted from said memory; and
storing said data within said designated range in said memory.

16 A method, executed on an application in a computer, of editing data received from a different computer via a network, comprising:
a data reception step of receiving data that is extracted from a clipboard of said different computer, from said different computer via said network;
a designation step of designating a position whereat said data is to be displayed by said application, and
a display step of displaying said received data at said designated position using said application.

17 The method according to claim 16, further comprising the step of:
transmitting to said different computer a request for data stored on said clipboard of said different computer, before performing said data reception step.

18 The method according to claim 16, wherein said data received from said different computer is image data, further comprising:
a storage step of storing said data output at said display step as an image that is to be displayed if said computer is in a predetermined state.

19 A method of generating a computer program, comprising the steps of:
receiving range designation for source code of a first computer program that is displayed using an application executed by a first computer;
storing, in accordance with an external operation of cutting or copying, data of said source code within said designated range on a clipboard at said first computer;
extracting said data from said clipboard upon reception of a predetermined command;
transmitting said extracted data to a second computer via a network;
receiving said transmitted data at said second computer; and
outputting said source code based on said received data as the source code for a second computer program that is displayed using an application executed by said second computer.

20 A computer program product comprising a computer useable medium having computer program logic recorded thereon for enabling a processor in a computer to transmit data to a different computer through a network, the computer program logic comprising:
means for enabling the processor to store data within the range designated by a user, in a memory of said computer;
means for enabling the processor to extract said data from said memory of said computer upon reception of a predetermined command; and
means for enabling the processor to transmit said extracted data via said network.
